(19) United States
(12) Patent Application Publication
(10) Pub. No.: US 2006/0226804 A1
(43) Pub. Date: Oct. 12, 2006

(54) Mobil phone battery replacement apparatus

(75) Inventor: Wen-Hui Lu, Taipei (TW)

Correspondence Address: GENUS LAW GROUP, 5543 TALON COURT, FAIRFAX, VA, 22032, US

(73) Assignee: Inventec Corporation

(21) Appl. No.: 11/104,145

(22) Filed: Apr. 12, 2005

(51) Int. Cl. H02J 7/00

(52) U.S. Cl. 320/107

(57) ABSTRACT

A battery replacement apparatus comprises a phone body with at least an open slide seat and a battery with at least a slider. By the slider, the battery can attach to the phone body and slide in a certain direction on the phone body. When there is a need for replace a spare battery, the user shift outward but not take out a running low battery located on the open slide seat of the phone body. Then attach a spare battery into the open slide seat of the phone body by the slider. Next, move the spare battery with a certain direction to the phone body until the running low battery out of the phone body and the spare battery is locked. The apparatus can let a user to replace a battery without turning off the mobile phone.

### BACKGROUND OF THE INVENTION

1. Field of the Invention

This invention relates to a battery replacement apparatus and, more particularly, to a battery replacement apparatus which is used for replacing a battery on the mobile phone.

2. Description of Related Art

At this information age, because mobile phones facilitate and expedite the communication of people and also shorten space-time distance, they become people's daily associate of necessity. According to the current technology, when a mobile phone is running low of power, generally, the phone will give a warning signal or message to notify the user.

Conventional mobile phone's replacement apparatus of battery is shown in FIG. 1. A mobile phone 10 includes a phone body 11, a battery 12 and a locker 13. The phone body 11 has a connector 111 and a locker 13. The locker 13, located in the phone body 11, includes a pusher 131 and a spring 132. When a mobile phone battery is running low of power, generally speaking, the user will turn off the mobile phone first, and then the user will push the pusher 131 toward the directions of the spring 132, so the battery 12 will be released by the uplifting of the connector 111. Next, the user takes out the battery 12 which is running low of power and replaces a new one (called “spare battery”, not shown in the FIG.). Then, the user pushes the pusher 131 toward the direction of spring 132 and then turn on the mobile phone. The conventional battery replacement apparatus needs users to take apart the battery 12 with one end of the battery as a supporting point for releasing, and then replace a spare battery, so it is troublesome that a variety of actions are involved.

Due to the conventional battery replacement apparatus not being able to release a battery with continuity actions and inconvenience the users, as mentioned above, there's a need to improve the apparatus of the battery replacement for mobile phones.

### SUMMARY OF THE INVENTION

The object of the invention is to provide a battery replacement apparatus for mobile phones that the users can replace a spare battery without turning off the mobile phone.

In order to let users replace a spare battery without turning off the mobile phone, this invention provide a new apparatus of battery replacement for mobile phones. The apparatus includes a phone body with at least an open slide seat and a battery with at least a slider. By the slider, a spare battery can attach to the phone body and slide in a certain direction on the phone body. When there is a need for replace a spare battery, the user shift outward but not take out a running low battery located on the open slide seat of the phone body. Then attach a spare battery into the open slide seat of the phone body by the slider. Next, move the spare battery with a certain direction to the phone body until the running low battery out of the phone body and the spare battery is locked to avoid shifting.

Therefore, this invention can let users replace a spare battery into the mobile phone without turning off the mobile phone. It can facilitate users for easy battery replacement and shorten the replacement time. For those persistent users, it can reduce the frequency of missing calls.

About this invention's detailed description and embodiments of the invention applicable will be more fully understood as specify herein below with the illustrations:

### BRIEF DESCRIPTION OF THE DRAWINGS

FIG. 1 is a structure view of a conventional apparatus of battery replacement of mobile phones;

FIGS. 2A and 2B are structure views of this invention's apparatus of battery replacement of mobile phones;

FIGS. 3A and 3B are descriptive views of this invention's battery sliding directions;

FIGS. 4A and 4B are structure views of this invention's open slide seat;

FIGS. 5A to 5C are structure views of this invention's slide track and slide way; and

FIGS. 6A to 6C are descriptive views of the process of battery replacement of the invention.

### DESCRIPTION OF THE PREFERRED EMBODIMENTS

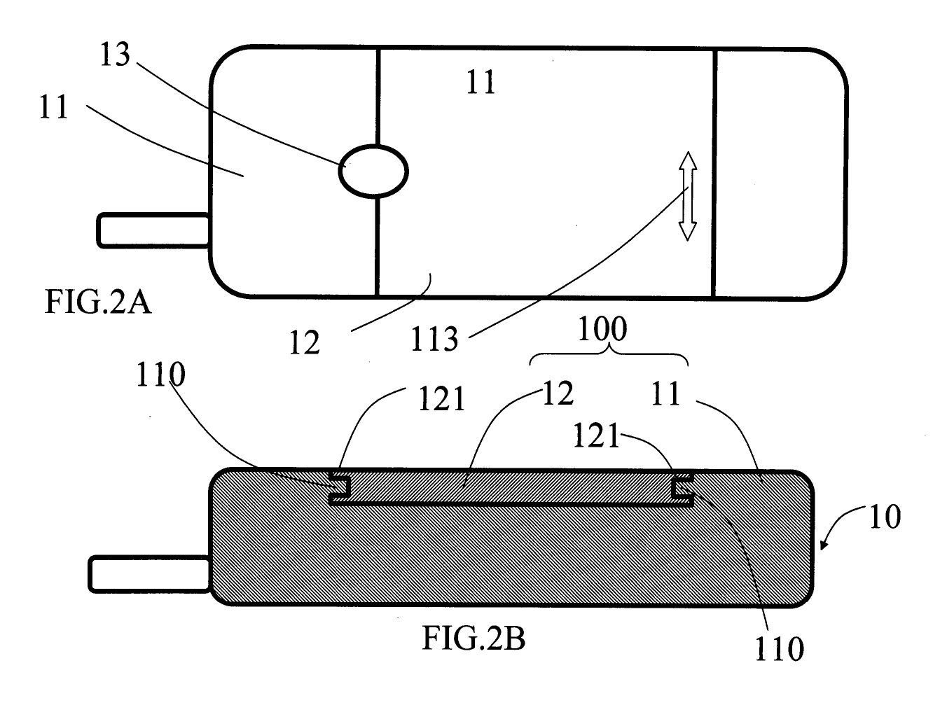

Referring to FIGS. 2A and 2B, the apparatus of mobile phone battery replacement of this invention is illustrated. The mobile phone battery replacement apparatus 100 of a mobile phone 10 comprises a phone body 11 with at least an open slide seat 110 and a battery 12 with at least a slider 121. By the slider 121, the battery 12 can attach to the phone body 11 and slide in a certain direction 113 (included but not limited to straight or curve movement) on the phone body 113.

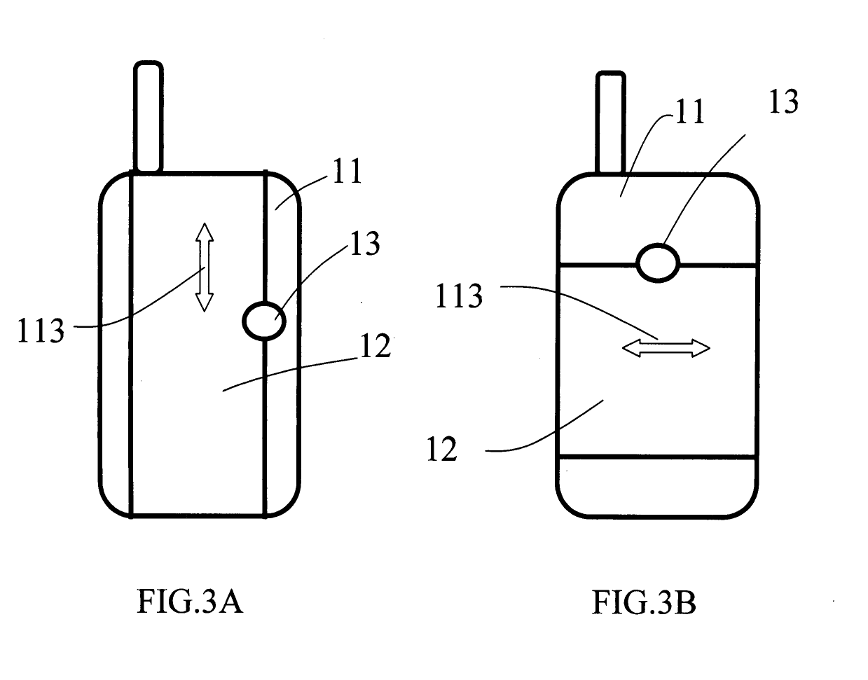

Referring to FIGS. 3A and 3B, the sliding directions as the arrows shown of the battery of this invention is illustrated. The battery 12 can be slid toward either left or right direction. It allows users to replace a spare battery (not shown) without trouble of turning off the phone.

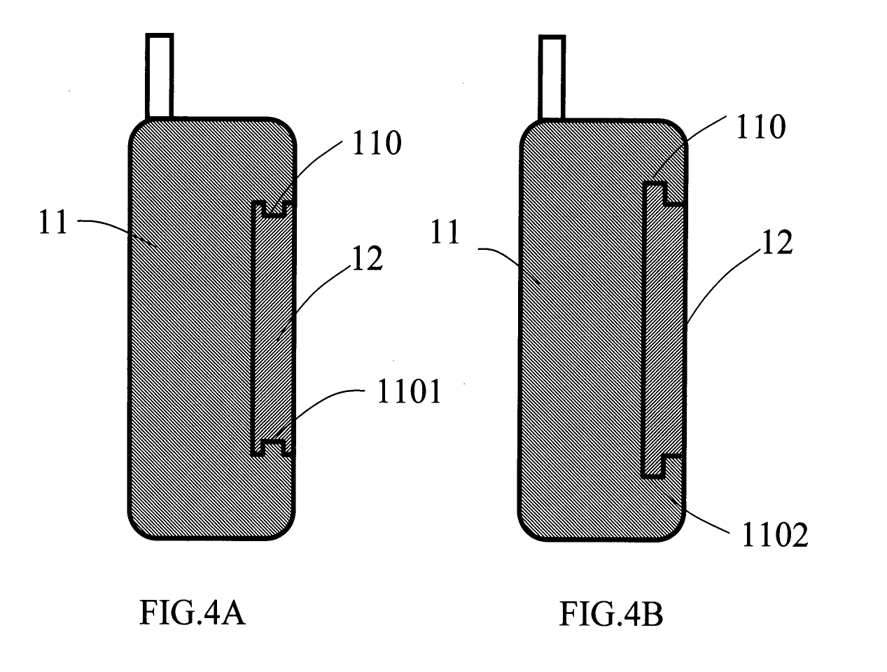

Referring to FIGS. 4A to 4Bb, the design of the open slide seat of this invention is illustrated. The embodiment of the open slide seat 110 can be either of a slide track 1101 (of convex appearance) or a slide way 1102 (of concave appearance). The function of the open slide seat 110 is to guide the sliding direction (not shown) of the battery 12 and let the battery 12 attach to the phone body 11.

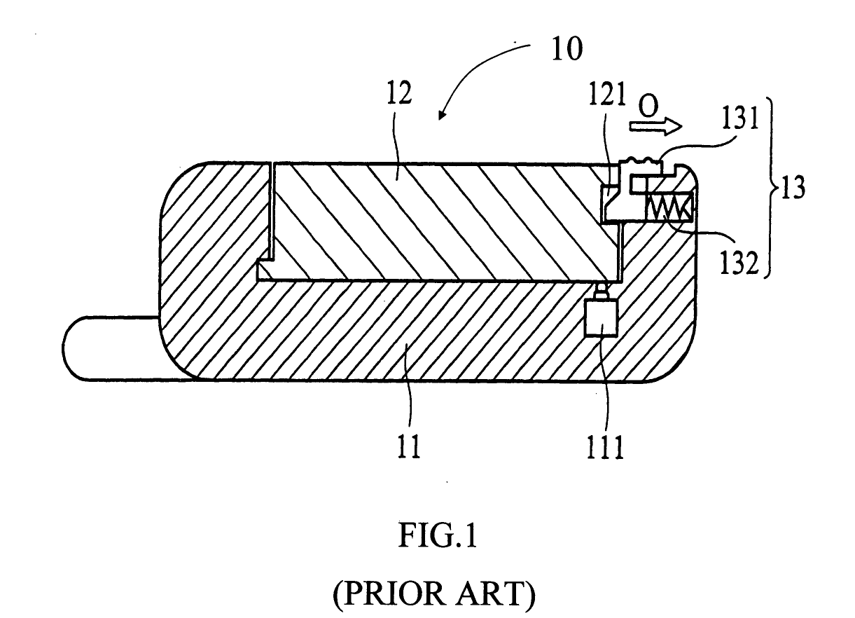

As shown in FIGS. 3A to 4B, in order to avoid the battery 12 shifting randomly on the slider 110, the apparatus has a locker 13 to limit the movement of the battery 12. The locker 13, as shown in FIG. 1, includes a spring 132 and a pusher 131. To replace the battery 12, the user needs to press the pusher 131 to release the locker 13 and then pushes the battery 12 outward. When the spare battery 14 is inserted from outward to inward of the phone body 11 and reached to a correct position, the locker 13 will lock the spare battery 14 on the phone body 11.

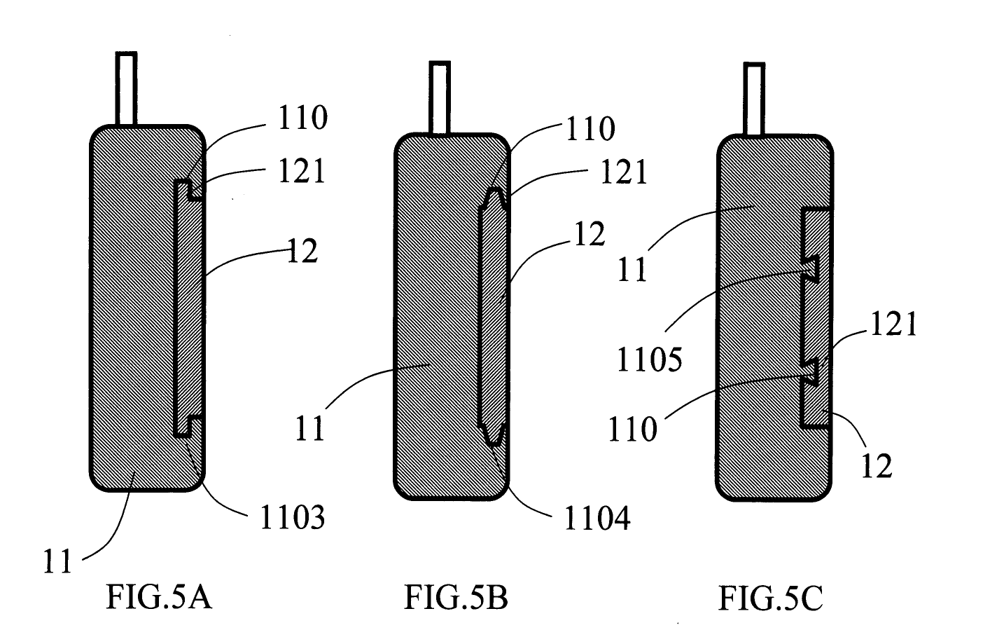

Referring to FIGS. 5A to 5C, the designs of open slide seat of this invention is illustrated. The shapes of the open slide track 1101 and the slide way 1102 include but are not limited to flat shape 1103, V shape 1104 or dovetail shape 1105 or any others (such as half moon shape, trapezoid, . . . etc), but the slider 121 of the battery 12 should have shapes that fit into the shapes of the slider accordingly to allow the battery 12 patch well with the phone body 11 and slide at the directions as the arrows shown.

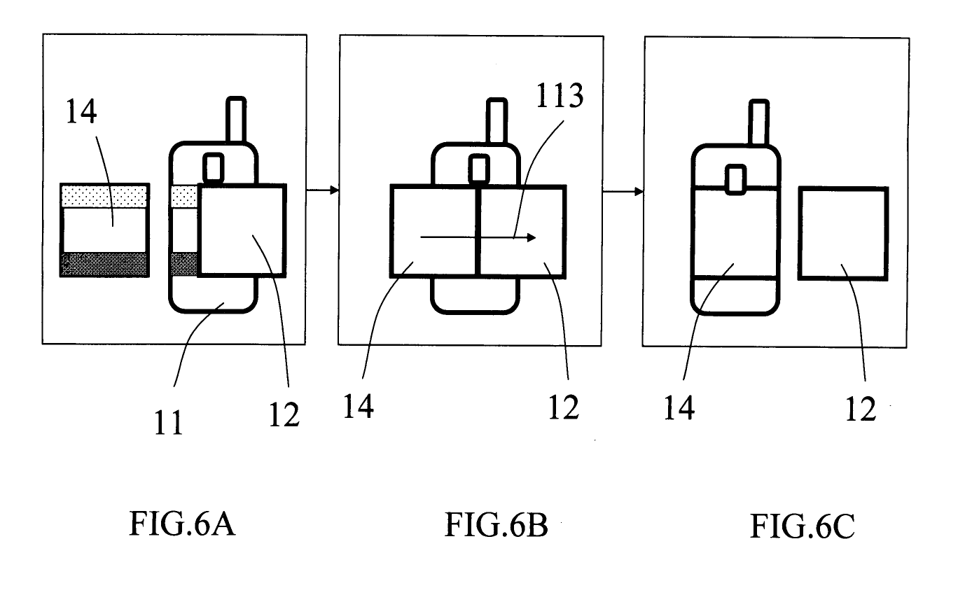

Referring to FIG. 6A to 6C, the battery replacement process to be taken of this invention is illustrated. In order to have the full understanding of the embodiment, please refer to FIG. 2 as a cross-reference. As FIG. 6A shown, to replace a spare battery 14, the user needs to shift the battery 12 first. Then, as shown in FIG. 6B, set the slider 121 of the battery 14 to the open slide seat 110, then the user can move the spare battery 14 toward the directions 113. At the same, the battery 12 will be pushed by the spare battery 14 until out of the phone body 11. Next, as shown in FIG. 6C, lock the spare battery 14 on the phone body 11.

The invention being thus described, it will be obvious that the same may be varied in many ways. Such variations are not to be regarded as a departure from the spirit and scope of the invention, and all such modifications as would be obvious to one skilled in the art intended to be included within the scope of the claims.

What is claimed is:

1. A mobile phone battery replacement apparatus, comprising:
a phone body having an open slide seat; and
a battery having a slider, wherein said slider and said open slide seat being connected with each other so that said battery can attach to said phone body and slide at certain directions.

2. A mobile phone battery replacement apparatus according to claim 1, wherein said open slide seat includes a slide track or a slide way.

3. A mobile phone battery replacement apparatus according to claim 2, wherein said slide track shape includes a flat shape, a V shape or a dovetail shape.

4. A mobile phone battery replacement apparatus according to claim 2, wherein said slide way shape includes a flat shape, a V shape or a dovetail shape

5. A mobile phone battery replacement apparatus according to claim 1, said apparatus further comprises a locker and said locker locks said battery to said phone body.

6. A mobile phone battery replacement apparatus according to claim 5, wherein said locker includes a spring and a pusher.
